(19) United States
(12) Patent Application Publication
(10) Pub. No.: US 2003/0099360 A1
(43) Pub. Date: May 29, 2003

(54) Time-based encryption key

(76) Inventor: Khoi Hoang, Pleasanton, CA (US)

Correspondence Address: Brian R. Coleman, Patent Attorney, Perkins Coie LLP, P.O. Box 2168, Menlo Park, CA, 95026-2168, US

(21) Appl. No.: 09/997,045

(22) Filed: Nov. 28, 2001

(51) Int. Cl. H04L 9/00

(52) U.S. Cl. 380/277

(57) ABSTRACT

A method and system are disclosed for securely transmitting a data message. In a method of the invention, a first encrypting key is obtained. A second encrypting key is then generated as a function of the first encrypting key and as a function of an identified parameter. The identified parameter can be time or some other random number. A requirement is that the parties desiring to communicate both have knowledge of the identified parameter. The data message is then encrypted using the second encrypting key to generate an encrypted message. The encrypted message can then be securely transmitted. A party receiving the encrypted message then obtains a first decryption key. A second decrypting key is then generated as a function of the first decrypting key and as a function of the identified parameter. The encrypted message is decrypted using the second encrypting key to recover the data message.

### FIELD OF THE INVENTION

The present invention relates to the field of secure digital communications. More particularly, the present invention relates to secure digital communication using encryption.

### BACKGROUND OF THE INVENTION

In the area of digital communication there exist many ways in which to distribute digital information. There are wired and wireless communication. Wired communication can be in the form of electrical or optical transmissions. Wireless communications can be in the form of RF or IR transmissions. Of course, there are many more manners of transmitting digital transmissions. Also, there are many schemes for transmitting such digital data, two of which are important for the purposes of establishing a foundation for the present invention.

Single-point-to-single-point transmissions as well as single-point-to-multiple-point transmissions find widespread use in digital communication. FIG. 1 is a block diagram of a single-point-to-single-point communication system 100. In the single-point-to-single-point communication system 100, an exclusive communication channel 110 is established between Alice and Bob having use of communication stations 102 and 104, respectively. As shown, the exclusive communication channel is composed of various path segments 110a-f that connect communication stations 102 and 104 through a network 112 that may be for example the internet. Through correct addressing of messages, an exclusive channel 110 is created within network 112.

As further shown in FIG. 1, communication stations 106 and 108 are also connected to network 112. Because a message sent from Alice and intended for Bob, creates an exclusive communication channel 110, Charles or Dan at communication stations 106 and 108 cannot inadvertently receive messages intended for Bob. Notably, exclusive communication channel 110 exists as a path through network 112. Where network 112 comprises many individual connections, there exists the possibility that an adversary to Alice or Bob, may intercept messages intended for Bob. Where network 112 is a private network such as a local area network (LAN), a disgruntled employee can pose a threat to secure communications especially where the disgruntled employee has a high level of access to network 112. Where network 112 is a public network such as the internet, many unknown individuals can attack exclusive communication channel 110 at many different points along the channel.

Where authorized use of digital data is a concern, various schemes exist for ensuring authorized use in a single-point-to-single point communication system 100. Where Alice does not desire that Bob receive certain information, Alice simply refrains from transmitting such information. Where Alice desires to send specific information to Bob, Alice, of course, transmits such information. Certainly, any information existing on exclusive communication channel 110 can be assumed to be authorized for Bob's consumption. In a single-point-to-single-point communication system 100, it is, nonetheless, possible that an unauthorized user may have gained access to the communication channel. Accordingly, where further security is desired, Alice may encrypt any message intended for Bob. With knowledge of the encrypting scheme and further knowledge of a decryption key, Bob is assured of being the only recipient that can decrypt and understand the received information.

Even with encryption, however, security can be compromised when the same encryption and decryption keys are used for an extended period of time. When the same keys are used for too long, an attacker to the communication system 100 has an extended period of time in which to discern the decryption key.

In a single-point-to-multiple-point communication system 200 such as that shown in FIG. 2, a non-exclusive communication channel 210 is available to the communicating parties, Alice and Bob, at communication stations 202 and 204, respectively. In this scheme, however, the communication channel 210 is also available to other parties, Charles and Dan at communication stations 206 and 208, respectively. When Alice, at communication station 202, desires to communicate a message to Bob at communication station 204, Alice places the message on non-exclusive communication channel 210. Bob can then retrieve the message. Notably, because Charles and Dan at communication stations 206 and 208, respectively, also have access to non-exclusive communication channel 210, Charles and Dan can also retrieve the message. Accordingly, single-point-to-multipoint communication system 200 is well suited for transmitting broadcast messages intended for all parties, but poses problems when private communications are desired.

In single-point-to-multiple-point communication system 200, the basic mode of operation requires that multiple users simultaneously receive a transmitted message. Where Alice desires to send a message only to Bob, he cannot avoid that Charles and Dan also receive the message. Thus, in order to prevent unauthorized use of a message intended only for Bob, Alice must take additional steps. As for the single-point-to-single point communication system 100, Alice may encrypt a message intended only for Bob. Here again, however, security can be compromised when the same encryption and decryption keys are used for an extended period of time. Single-point-to-multiple-point communication system 200, is even more insecure because an attacker need does not need to take any special steps to gain access to the non-exclusive communication channel 210.

The internet is an example of a single-point-to-single point communication system 100. Through proper addressing, Alice directs a message to an identified recipient, Bob. Because the internet exists as a worldwide network, many opportunities exist for an unauthorized user to intercept a message intended only for Bob. A digital cable television system is an example of a single-point-to-multiple-point communication system 200. Many users are in constant receipt of the same transmitted messages such that when Alice directs a message to Bob, Charles and Dan also receive the message. Even where a encryption is used, Charles or Dan may be able to figure out the encryption and decryption keys such that they may be able to intercept messages intended only for Bob.

It is therefore an object of the present invention to increase the security of digital communication systems. It is a further object of the invention to ensure the authorized use of a transmitted message. It is yet another object of the invention, to increase the security of single-point-to-single-point, as well as, single-point-to-multipoint systems. It is yet another object of the invention to increase the security of a communication system using an encryption scheme by continuously changing public encryption keys.

### SUMMARY OF THE INVENTION

In an embodiment of the invention a method and system are described for securely transmitting a data message. In a method of the invention, a first encrypting key is obtained. A second encrypting key is then generated as a function of the first encrypting key and as a function of an identified parameter. The identified parameter can be time or some other random number. A basic requirement is that the parties desiring to communicate both have knowledge of the identified parameter. The data message is then encrypted using the second encrypting key to generate an encrypted message. The encrypted message can then be securely transmitted.

A party receiving the encrypted message then obtains a first decryption key. A second decrypting key is then generated as a function of the first decrypting key and as a function of the identified parameter. The encrypted message is decrypted using the second encrypting key to recover the data message.

In another embodiment of the invention, encrypting step corresponds to a public key encryption scheme such as RSA. In yet another embodiment, the encrypting step corresponds to a secret key encryption scheme such as DES.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 (Prior Art) is block diagram of a single-point-to-single point communication system according to the prior art.

FIG. 2 (Prior Art) is a block digram of a single-point-to-multiple point communication according to the prior art.

FIG. 3 (Prior Art) is a flowchart of a method for generating keys in a public key encryption scheme according to the prior art.

FIG. 4 (Prior Art) is a flowchart of a method for encrypting a message in a public key encryption scheme according to the prior art.

FIG. 5 (Prior Art) is a flowchart of a a method for decrypting a message in a public key encryption scheme according to the prior art.

FIG. 6 is a flowchart of a method for generating a set of public keys, private keys and secret functions according to an embodiment of the invention.

FIG. 7 is a flowchart of a method of securely transmitting data according to an embodiment of the invention.

FIG. 8 is a flowchart of a method of securely receiving data according to an embodiment of the invention.

FIG. 9 is a block diagram of a communication system having encryption and decryption modules according to an embodiment of the invention.

### DETAILED DESCRIPTION OF THE PREFERRED EMBODIMENTS

The present invention, ensures the authorized use of digital data by incorporating methods of data encryption as part of the invention. Upon understanding the present disclosure, one of skill in the art will understand that many encryption schemes are appropriate. For purposes of illustration, the present invention will be described in the context of an RSA public key encryption scheme.

A. Generation of Keys

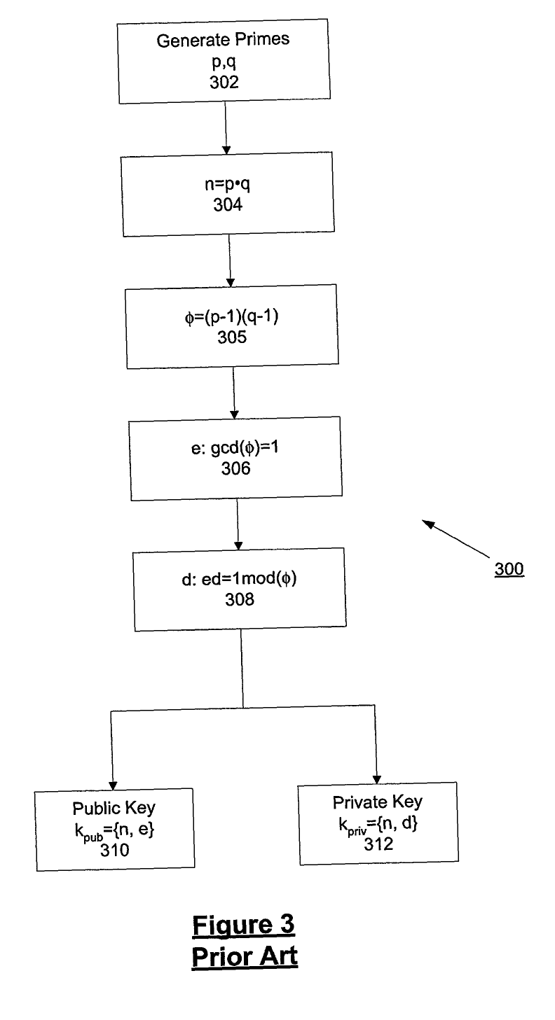

Central to the use of public key encryption is the generation of the public and private keys. FIG. 3 is a flowchart of a method 300 for generating a public key, {n, e}, and a private key, {n, d}. At step 302, two large random prime numbers, p and q, are generated. Various prior art methods exist for generating the large random prime numbers, p and q. A modulus, n, is computed as the product of p and q at step 304:

n=p·q.

Moreover, at step 305, the relatively prime number, φ, is computed as the product of p−1 and q−1:

φ=(p−1)·(q−1).

With knowledge of φ, at step 306, an encryption exponent e is selected such that the greatest common divisor of e and phi is equal to 1 where e is greater than 1 and less than φ:

{e:gcd(φ)=1,1≦e≦φ}

The decryption exponent is then generated at step 308. The decryption exponent, d, is computed such that the product of e and d satisfies the congruence ed=1 mod φ, where d is greater than 1 and less than phi

{d:e·d=1mod(φ),1≦d≦φ}.

The calculations for the public and private keys are then complete. At step 310, the public key is collected as the pair, {n, e}, and, at step 312, the private key is collected as the quantity, {n, d}:

K_{public}{n,e}, and

Kₚᵣᵢᵥₐₜₑ={n,d}.

B. Encryption of a Message

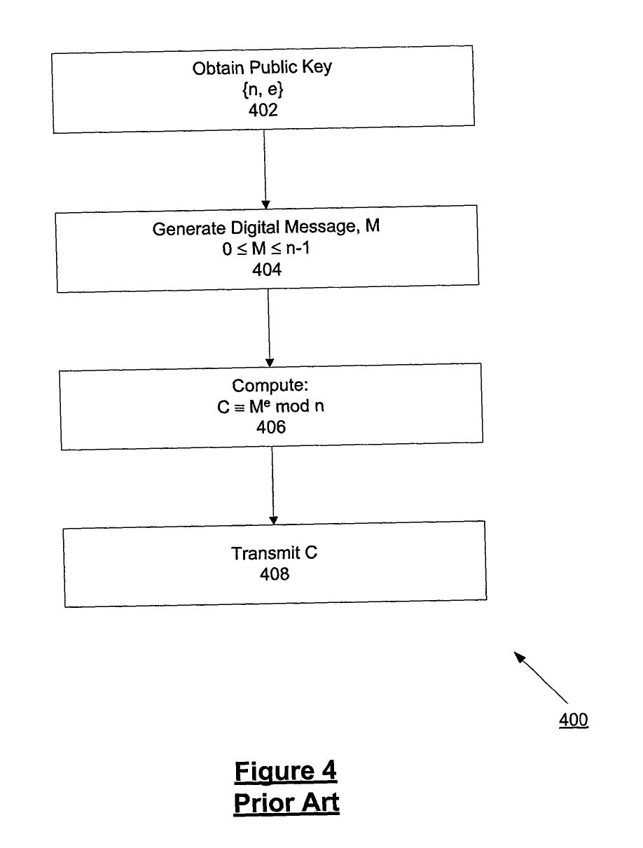

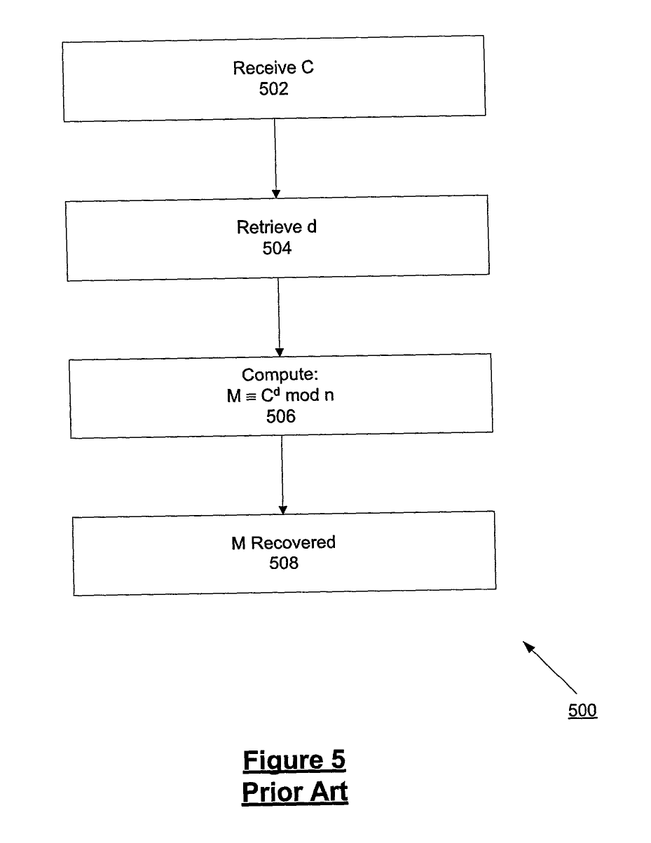

The public and private keys can then be used to establish secure communications. A method 400 for encrypting a message, M, is shown in FIG. 4 and a method 500 for decrypting a received message is shown in FIG. 5. The method of FIG. 4 shows a flowchart for a method 400 for secure transmission of a message, M, from Alice to Bob. At step 402, Alice obtains Bob's public key, {n, e}. The public key can be obtained directly form Bob or from a third party providing a storage service of storing and making available public keys from multiple parties. Having obtained Bob's public key, {n, e}, Alice generates a digital message, M, where M is greater than or equal to 0 and less than or equal to n−1. Where Alice desires to send a message Z where Z is greater than n−1, message Z can be broken up into a plurality of blocks, Z1, Z2, . . . , where each such message block meets the condition that it is greater than or equal to 0 and less than or equal to n−1. Thus, each of the plurality of blocks, Z1, Z2, . . . , is sequentially replaced as the message M in the method of FIG. 4. With the digital message, M, an encrypted message, C, is computed at step 406. The encrypted message, C, is also referred to as the ciphertext message, and the message, M, is also referred to as the data message. The encrypted message, C, is obtained by computing the congruence

C=M^{e}mod n.

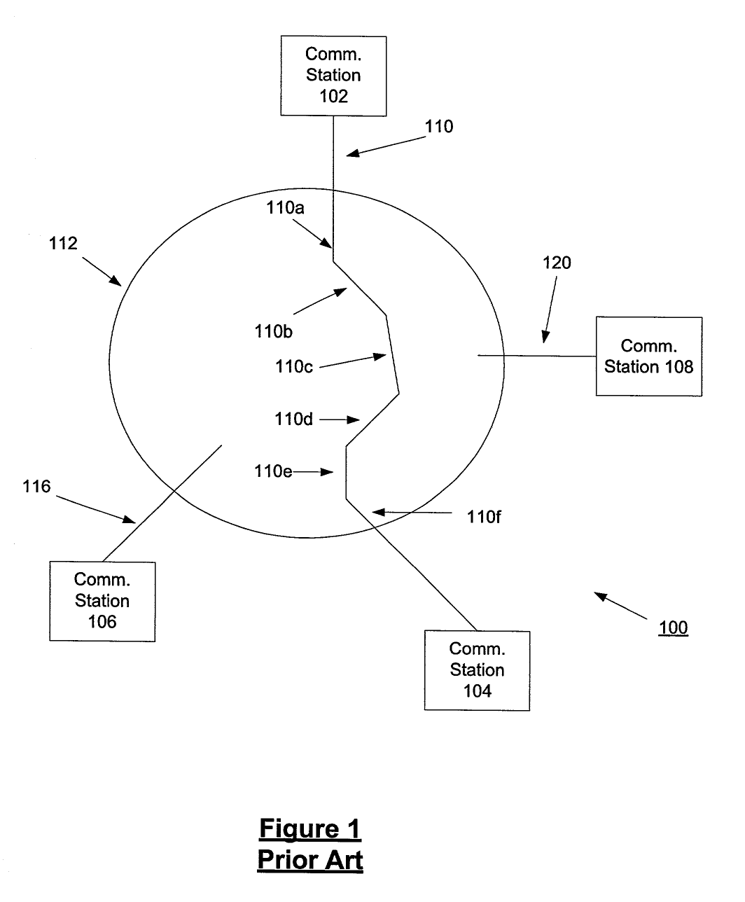

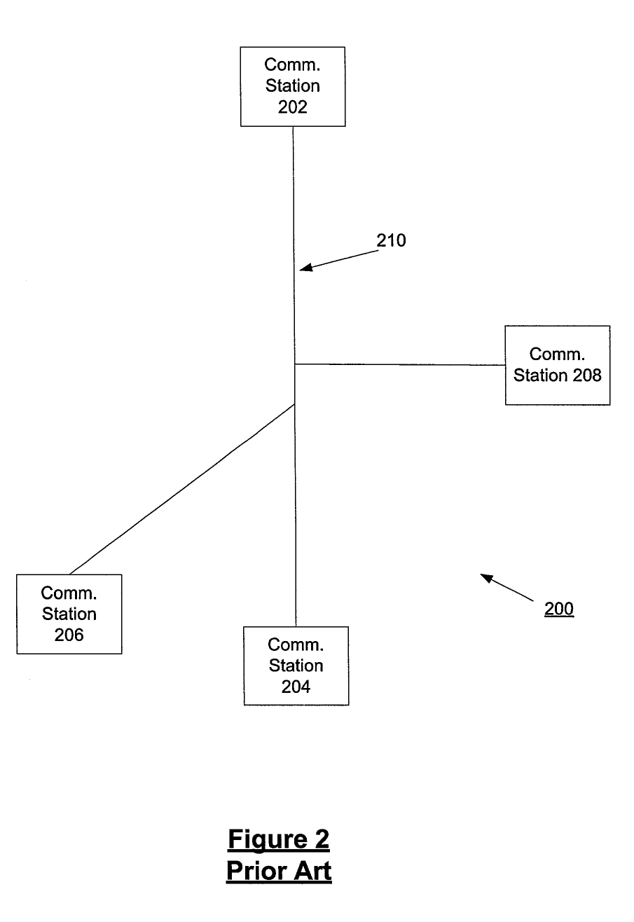

The encrypted message, C, is then transmitted by Alice to Bob at step 408. Importantly, the encrypted message, C, can be transmitted using an unsecure transmission medium. The unsecure transmission medium can be any medium capable of transmitting digital information such a wired, wireless, or infrared communication systems including those described for FIGS. 1 and 2. Having transmitted the encrypted message, Alice need not perform any further tasks.

C. Decryption of a Message

We turn now to a method 500 for decrypting an encrypted message, C, as shown in FIG. 5. As shown in FIG. 5, Bob receives the encrypted message, C, at step 502. Bob then retrieves the private key, {n, d}, at step 504. For optimal security private key, {n, d}, should be securely stored. Moreover, when private key, {n, d}, is retrieved and in use, the security of any machine or device performing the decryption should also be maintained. With the private key, {n, d}, the data message M is generated at step 506 by computing the congruence

M=C^{d}mod n.

Thus, at step 508, the data message, M, is recovered.

D. Transmission of Large Messages

Through completion of the methods of FIGS. 4 and 5, Alice has then communicated a data message, M, to Bob over an unsecured transmission medium. Where Alice may have transmitted a large message Z as multiple data messages, Z1, Z2, . . . , Bob can recover the large message Z by collecting the multiple decrypted messages. Indeed, present day communication is such that the more typical situation is that a large message Z will be desired to be transmitted.

To transmit a large message, however, can be computationally expensive. Computational cost can be measured in computer operations or time. Where a message Z is very large, computational cost becomes even more important. For example, where a digitized movie having a size of many gigabytes is desired to be viewed only by an authorized recipient, the entire movie can be encrypted where party B has an appropriate decryption key.

In transmitting large messages (e.g., a digital movie), both a single-point-to-single-point and single-point-to-multiple-point communication schemes establish a connection between two communicating parties for an extended period of time. This extended connection time makes the communication schemes vulnerable to attack. Basically, the longer a communication channel exists with the same encryption keys, the more vulnerable to attack the communication channel becomes.

As encryption technology has advanced so have the manners of attacking encryption. Although better method of encryption are continually becoming available, it has been found that changing of encryption and decryption keys provides an increased level of security. To change keys, however, can be a cumbersome task. For example, to generate the large random prime numbers, p and q, as discussed for FIG. 1, can be computationally expensive. Moreover, as modem communication requires more security, the random prime numbers are required to be even larger making them even more computationally expensive. An embodiment of the present invention, however, provides a method for continuously changing the keys of an encryption scheme.

E. Generation of Keys According to an Embodiment of the Invention

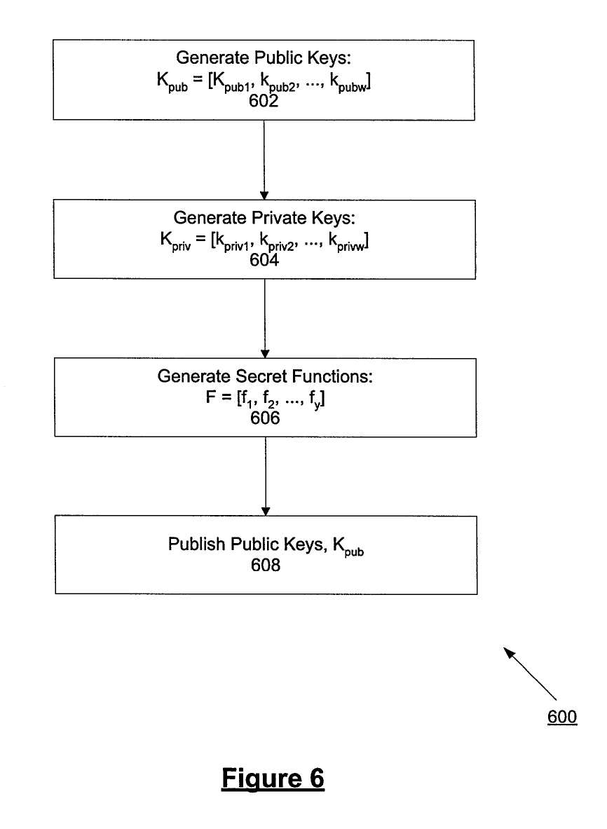

Shown in FIG. 6 is a method 600 for generating a multidimensional array of keys according to an embodiment of the invention. At step 602 an array, K_{pub}, of public keys is generated in a manner consistent with FIG. 3. K_{pub} contains elements k_{pub,i} where 1≦i≦w. Moreover, at step 604, an array of private keys, Kₚᵣᵢᵥ, is generated where each element, k_{priv,i}, in Kₚᵣᵢᵥ corresponds to an element, k_{pub,i}, in K_{pub}. At step 606, an array, F, of secret functions is generated. Array F contains elements fⱼ where 1≦j≦y. The functions in array F will be described further below. The array of public keys is published or distributed at step 608.

F. Transmission of Data According to an Embodiment of the Invention

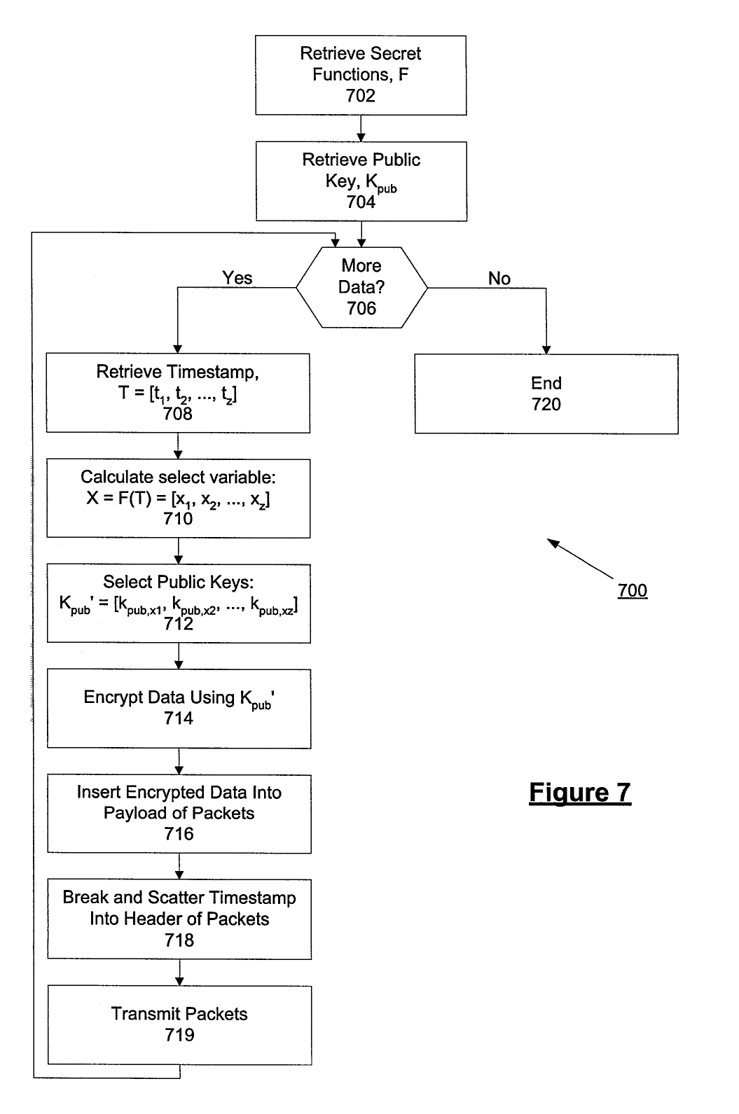

Transmission of encrypted data is achieved in the present invention by executing method 700 as shown in FIG. 7. In order for a transmitting party, say Alice, to transmit an encrypted message to a receiving party, say Bob, Alice must have available the array of secret functions, F, and the array of public keys, K_{pub}. Accordingly, the array of secret functions, F, are retrieved at step 702 and the array of public keys, K_{pub}, are retrieved at step 704. A query at step 706 is then made as to whether there is more data to transmit. Where there is no data to transmit, step 720 is executed and the method 700 is terminated. Where there is data to transmit, step 708 is executed. At step 708, a parameter, T, of the data is retrieved. In an embodiment of the invention, the parameter, T, is a timestamp associated with the data to be transmitted. A timestamp can be a time associated with the time a packet of data was generated. Moreover, a timestamp can be the time a packet of data is generated. In proceeding with the description of the present invention, the timestamp will be further described, however, one of skill in the art will understand that other parameters of the data can be used.

At step 710, the function, F, introduced above, is used with timestamp, T, as input to generate a select variable, X, with elements, xₖ, where 1≦k≦z. The select variable, X, therefore, has as its elements xₖ=x₁, x₂, . . . , x_{z}. The elements, xₖ, are then used to select elements of the public key array, K_{pub}, such that a second array of public keys, K_{pub}′, is generated at step 712. The second array of public keys, K_{pub}′, has as its elements, k_{pub,x1}, k_{pub,x2}, . . . , k_{pub,xz}. For clarity, a non-limiting example will now be described.

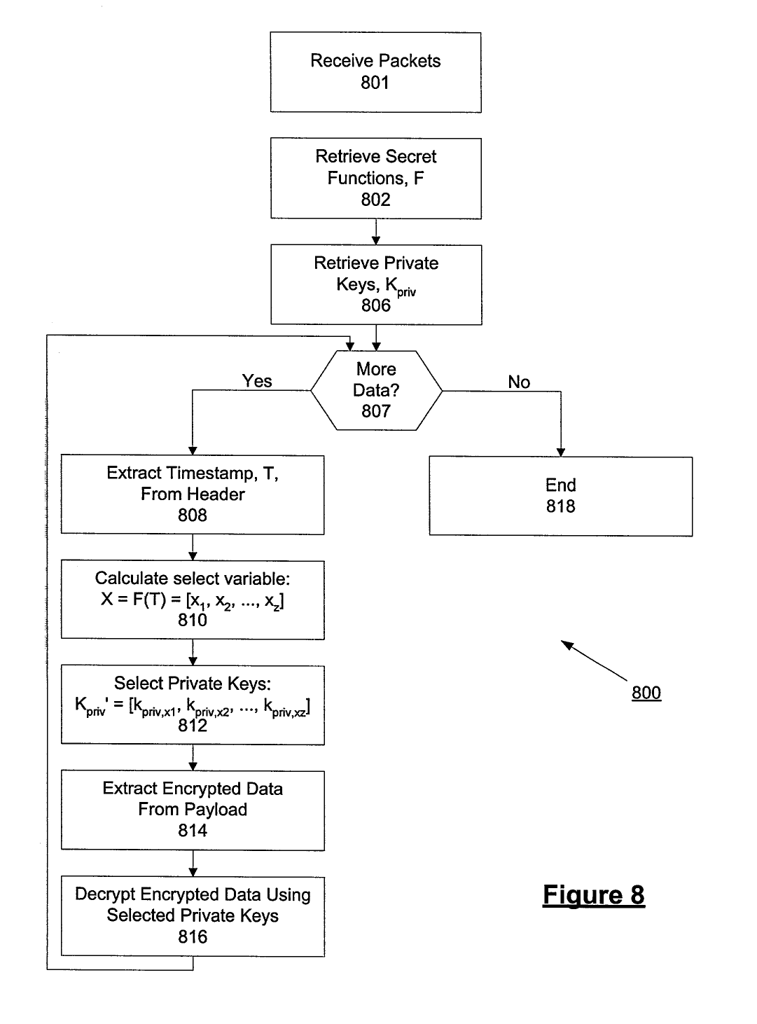

In an embodiment of the invention, the secret function, F, is a 1×1 array having only the element f₁=T mod 3. In this embodiment, the timestamp is represented as an integer value such that the function, f₁=T mod 3, has as possible outputs 0, 1 and 2. Thus, the elements of Kpub and Kpriv are chosen to have elements with indexes having values 0, 1 and 2, ie K_{pub}=[k_{pub,0}, k_{pub,1}, k_{pub,2}] and Kₚᵣᵢᵥ=[k_{priv,0}, k_{priv,1}, k_{priv,2}]. The select variable, X, can then be used to create a second public key, K_{pub}′, having elements, k_{pub}′. that will be used for encryption. Similarly, the select variable, X, can be used to create a corresponding second private key, Kₚᵣᵢᵥ′, having elements, k_{priv,x}, that will be used for decryption. To continue with the example, assume that the function f₁ generates the select variable X=[1, 2, 0, 1, 2] for a particular set of timestamps. The second array of public keys then becomes K_{pub}′=[k_{pub,1}, k_{pub,2}, k_{pub,0}, k_{pub,0}, k_{pub,1}, k_{pub,2}]. Similarly, the second array of private keys, to be described with reference to FIG. 8 below, is selected as Kₚᵣᵢᵥ′=[k_{priv,1}, k_{priv,2}, k_{priv,0}, k_{priv,0}, k_{priv,1}, k_{priv,2}]. These second public and private keys can then be used for secure communication.

Returning to the description of method 700 of FIG. 7, the data under consideration is encrypted at step 714 using the selected public encryption key. The encrypted data is then inserted into a payload area of a protocol defined packet at step 716. Many protocol defined packets are known to one of skill in the art that would be appropriate for use with the present invention. Moreover, the timestamp is broken and inserted into the header of the protocol defined packets at step 718. At step 719, the protocol defined packets are then transmitted from Alice to Bob. The method then loops back to step 706 to check whether more data is present. Where more data is present, steps 708-719 are performed on such data. Where more data is not present the method is terminated at step 720.

G. Transmission of Data According to an Embodiment of the Invention

Reception of encrypted messages is achieved in the present invention by executing method 800 as shown in FIG. 8. At step 801, the transmitted packets are received by the receiving party, Bob. In order for a Bob to receive an encrypted message from transmitting Alice, Bob must have available the array of secret functions, F, and the array of private keys, Kₚᵣᵢᵥ. Accordingly, the array of secret functions, F, are retrieved at step 802 and the array of private keys, Kₚᵣᵢᵥ, are retrieved at step 806. A query at step 807 is then made as to whether there is more data to receive. Where there is no data to receive, step 818 is executed and the method 800 is terminated. Where there is data to receive, step 808 is executed. At step 808, a parameter, T, of the data is retrieved from the header of a protocol defined packet. In the present description, the parameter, T, is being described as a timestamp.

At step 810, the function, F, is used with timestamp, T, as input to generate a select variable, X, with elements xₖ where 1≦k≦z. The select variable X is as was described for FIG. 7. Here, the select variable, X, is used to select a second array of private keys, Kₚᵣᵢᵥ′, from the array of private keys, Kₚᵣᵢᵥ, corresponding to the second array of public keys, K_{pub}′, used in the method of FIG. 7. The elements, xₖ, of the select variable, X, are used to select elements of the private key array, Kₚᵣᵢᵥ, to create the second array of private keys, Kₚᵣᵢᵥ′, at step 712. The second array of private keys, K_{priv,i}′, has as its elements, k_{priv,x1}, k_{priv,x2}, . . . , k_{priv,xz}.

The example described for FIG. 7, with the secret function, F, as 1×1 array having only the element f1=T mod 3 will be further described. Recall that the function, fl, generates possible values of 0, 1 or 2. Because the same timestamp is used in method 800 of FIG. 8 as was used in method 700 of FIG. 7, the same outputs, X, will be generated at step 810 as was generated at step 710. Thus, corresponding private keys are chosen for the public keys that were used to encrypt the data. In the example described above, where the transmitting party, Alice, generated the array K_{pub}′=[k_{pub,1}, k_{pub,2}, k_{pub,0}, k_{pub,0}, k_{pub,1}, k_{pub,2}], the receiving party, B, generates Kₚᵣᵢᵥ′=[k_{priv,1}, k_{priv,2}, k_{priv,0}, k_{priv,0}, k_{priv,1}, k_{priv,2}].

Returning to the description of method 800 of FIG. 8, the encrypted data is extracted from the payload of the received packets at step 814. Such encrypted data is decrypted at step 816 using the selected private decryption key. The method then loops back to step 807 to check whether more data needs to be decrypted. Where more data is present, steps 808-816 are performed on such data. Where more data is not present the method is terminated at step 818.

As described, the methods of FIGS. 6-8 provide increased security with reduced computational cost. Reduced computational cost is achieved because the computationally intensive task of generating arrays of public and private keys need not be performed multiple times. By using many keys, the encryption and communication scheme of the present invention becomes less susceptible to attack even where an attacker has access to a communication for an extended period of time. Moreover, the arrays of public and private keys of the present invention, as well as the select functions can be changed periodically such that an attack to the system is further frustrated.

Many variations exist to the methods described for FIGS. 6-8. For example, instead of using the timestamp as a parameter of the data, other parameters can be used. For example, check sum information for a packet of data can be used. The select variable would then use such check sum information to select appropriate public and private keys. Moreover, synchronized random number generators available to both a transmitting and receiving party can be used instead of time. The basic requirement is that both parties know the parameter being used.

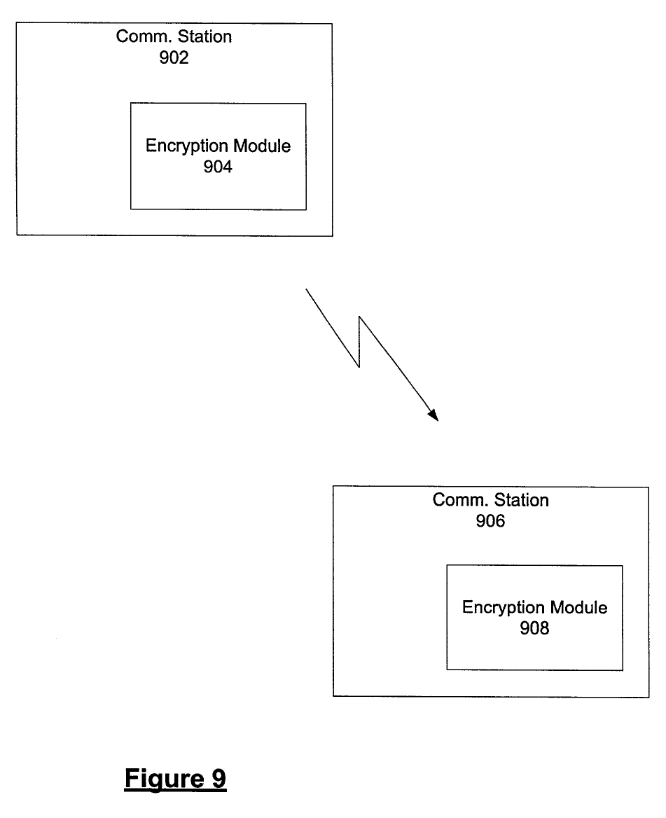

As described, a transmitting party must encrypt data while a receiving party must decrypt data. Thus, dedicated encryption and decryption modules can be configured within communication stations. As shown in FIG. 9, communication station 902 configured to transmit data contains an encryption module 904 that operates to encrypt data to be transmitted. Correspondingly, communication station 906 configured to receive transmitted data, contains a decryption module 908 that operates to decrypt encrypted data. Encryption module 904 and decryption module 908 can be implemented in hardware, software, or firmware. A software implementation can be easier to implement, however, a hardware implementation can provide for improved performance. A firmware implementation can provide a balance between software and hardware implementations.

Several preferred embodiments of the present invention have been described. Nevertheless, it will be understood that various other modifications can be made to the described invention without departing from its spirit and scope. For example, the present invention is not limited to any particular implementation or communication scheme, and the invention may be implemented using various techniques for achieving the functionality described herein. The invention can be achieved in software and hardware implementations. The invention may be implemented in any appropriate operating system using appropriate programming languages and/or programming techniques. Thus, the present invention is not limited to the presently preferred embodiments described herein, but may be altered in a variety of ways that will be apparent to persons skilled in the art based on the present description.

1. A method for securely transmitting a data message, comprising the steps of:
obtaining a first encrypting key;
generating a second encrypting key as a function of the first encrypting key and as a function of an identified parameter;
encrypting the data message using the second encrypting key to generate an encrypted data message; and
transmitting the encrypted data message.

2. The method of claim 1, wherein the encrypting step corresponds to a public key encryption scheme.

3. The method of claim 2, wherein the encryption scheme is an RSA scheme.

4. The method of claim 1, wherein the encrypting step corresponds to a private key encryption scheme.

5. The method of claim 4, wherein the encryption scheme is a DES scheme.

6. The method of claim 1, wherein the identified parameter is a time or time-dependent value.

7. The method of claim 1, wherein the identified parameter is a randomly generated number.

8. The method of claim 1, further comprising:
receiving the encrypted data message;
obtaining a first decryption key;
generating a second decrypting key as a function of the first decrypting key and as a function of the identified parameter;
decrypting the encrypted data message using the second decrypting key to recover the data message.

9. A method for securely receiving a data message, comprising the steps of:
obtaining a first decrypting key;
generating a second decrypting key as a function of the first decrypting key and as a function of an identified parameter;
decrypting the data message using the second decrypting key to generate the data message.

10. The method of claim 9, wherein the decrypting step corresponds to a public key encryption scheme.

11. The method of claim 10, wherein the encryption scheme is an RSA scheme.

12. The method of claim 9, wherein the decrypting step corresponds to a private key encryption scheme.

13. The method of claim 12, wherein the encryption scheme is a DES scheme.

14. The method of claim 9, wherein the identified parameter is a time or time-dependent value.

15. The method of claim 9, wherein the identified parameter is a randomly generated number.

16. The method of claim 9, wherein the encrypted data message is generated by a method comprising the steps of:
obtaining a first encrypting key;
generating a second encrypting key as a function of the first encrypting key and as a function of an identified parameter;
encrypting the data message using the second encrypting key to generate an encrypted data message; and
transmitting the encrypted data message.

17. A communication system for securely transmitting a data message, comprising:
a memory;
a processor configured to execute the steps comprising:
obtaining a first encrypting key;
generating a second encrypting key as a function of the first encrypting key and as a function of an identified parameter;
encrypting the data message using the second encrypting key to generate an encrypted data message; and
a transmitter for transmitting the encrypted data message.

18. The communication system of claim 17, wherein the encrypting step corresponds to a public key encryption scheme.

19. The communication system of claim 18, wherein the encryption scheme is an RSA scheme.

20. The communication system of claim 17, wherein the encrypting step corresponds to a private key encryption scheme.

21. The communication system of claim 20, wherein the encryption scheme is a DES scheme.

22. The communication system of claim 17, wherein the identified parameter is a time or time-dependent value.

23. The communication system of claim 17, wherein the identified parameter is a randomly generated number.

24. The communication system of claim 17, further comprising a receiver configured to receive the encrypted data message and wherein a second processor is configured to execute the steps comprising:
obtaining a first decryption key;
generating a second decrypting key as a function of the first decrypting key and as a function of the identified parameter;
decrypting the encrypted data message using the second decrypting key to recover the data message.

25. A communication system for securely receiving a data message, comprising:
a memory;
a receiver configured to receive an encrypted data message; and
a processor configured to execute the steps comprising:
obtaining a first decrypting key;
generating a second decrypting key as a function of the first decrypting key and as a function of an identified parameter; and
decrypting the data message using the second decrypting key to generate the data message.

26. The communication system of claim 25, wherein the decrypting step corresponds to a public key encryption scheme.

27. The communication system of claim 26, wherein the encryption scheme is an RSA scheme.

28. The communication system of claim 25, wherein the decrypting step corresponds to a private key encryption scheme.

29. The communication system of claim 28, wherein the encryption scheme is a DES scheme.

30. The communication system of claim 25, wherein the identified parameter is a time or time-dependent value.

31. The communication system of claim 25, wherein the identified parameter is a randomly generated number.

32. The communication system of claim 25, further comprising a transmitter configured to transmit the encrypted data message and wherein a second processor is configured to execute the steps comprising:
obtaining a first encrypting key;
generating a second encrypting key as a function of the first encrypting key and as a function of an identified parameter;
encrypting the data message using the second encrypting key to generate an encrypted data message.

33. A method for securely transmitting a data message, comprising the steps of:
obtaining a first array of encrypting keys;
generating a second array of encrypting keys as a function of the first encrypting key and as a function of an identified parameter;
encrypting the data message using the second array of encrypting keys to generate an encrypted data message; and
transmitting the encrypted data message.

34. The method of claim 33, wherein the encrypting step corresponds to a public key encryption scheme.

35. The method of claim 34, wherein the encryption scheme is an RSA scheme.

36. The method of claim 33, wherein the encrypting step corresponds to a private key encryption scheme.

37. The method of claim 36, wherein the encryption scheme is a DES scheme.

38. The method of claim 33, wherein the identified parameter is a time or time-dependent value.

39. The method of claim 33, wherein the identified parameter is a randomly generated number.

40. The method of claim 33, further comprising:
receiving the encrypted data message;
obtaining a first array of decryption keys;
generating a second array of decrypting keys as a function of the first decrypting key and as a function of the identified parameter;
decrypting the encrypted data message using the second array of decrypting keys to recover the data message.
